(19) United States
(12) Patent Application Publication
(10) Pub. No.: US 2021/0019675 A1
(43) Pub. Date: Jan. 21, 2021

(54) Monitoring And Assessment Of Built Environment And Demographic Information By Quantifying Exposure Of Population, Assets, And Infrastructure To Hazards

(71) Applicant: University of Hawaii, Honolulu, HI (US)

(72) Inventors: Douglas B. Bausch, Makawao, HI (US); Juliana Lo, Mililani, HI (US)

(21) Appl. No.: 16/931,620

(22) Filed: Jul. 17, 2020

Related U.S. Application Data
(60) Provisional application No. 62/875,934, filed on Jul. 18, 2019.

(51) Int. Cl. G06Q 10/06; G06F 16/245

(52) U.S. Cl. CPC G06Q 10/0635; G06F 16/245

(57) ABSTRACT

Information regarding hazards, built environment, and population demographics may be used to automatically generate reports of impacts and effects upon the built environment and the population in an area.

### CROSS-REFERENCE TO RELATED APPLICATIONS

This application claims priority from U.S. Patent Application Ser. No. 62/875,934 (Bausch), filed on Jul. 18, 2019, titled “All-hazard Impact Model (AIM),” the content of which is hereby incorporated by reference in its entirety.

### GOVERNMENT INTEREST

This invention was made with government support under HQ0034-16-2-0001 awarded by the Department of Defense. The government has certain rights in the invention.

### BACKGROUND

This disclosure relates generally to the field of data processing and modeling of hazards.

### SUMMARY

The present disclosure pertains to monitoring and assessment of potential impacts from hazards through quantifying exposure of population, assets, and infrastructure to the hazards.

Exposure is a critical component of assessing risk, potential impacts, and appropriately scaled response to events. However, existing systems to monitor and assess built environment and demographic information do not incorporate demographic factors, such as age and income level of the population of a region to estimate potential needs in an event response.

Further, existing systems to monitor and assess built environment and demographic information do not provide the distribution of built environment in rural and urban settings and aid in estimating building construction types useful in loss modeling.

Further, existing systems to monitor and assess built environment and demographic information do not provide population distribution by occupancy categories, including residential, commercial, and industrial, to estimate impacts to these sectors, peak day and night population exposures, as well as urban and rural households affected.

Further, while other population datasets exist, existing systems to monitor and assess the built environment and demographics may not provide exposure attributes that support all phases of emergency management.

Therefore, there is a need for improved methods and systems to facilitate monitoring and assessment of built environment and demographic information by quantifying exposure of the population, assets, and infrastructure to hazards that may overcome one or more of the above-mentioned problems and/or limitations.

A method to generate an impact report for an area based on built environment and demographic data is disclosed. The method may include receiving, using a communication device, input related to hazard information from one or more databases.

Further, the method may include receiving, using a communication device, input related to demographic information from one or more databases.

Further, the method may include analyzing, using a communication device, the hazard information and demographic information to determine an effect of the hazard on an area.

Further, the method may include generating, using the processing device, an impact report for an area.

Further, according to some aspects, a system to facilitate generation of an impact report for an area based on built environment and demographic data is disclosed.

The system may include a communication device configured to receive input related to hazard information from one or more databases, and input related to the built environment and demographic information from one or more databases. Further, the All-hazard Impact Model (AIM) system may include a processing device configured to analyze the hazard information, built environment, and demographic information to determine an effect of the hazard on an area, and generate an impact report for the area.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 is an illustration of an example online platform.

FIG. 2 shows a flowchart of an example method to generate an impact report for an area based on demographic data.

FIG. 3 shows an example system to facilitate generation of an impact report for an area based on demographic data.

FIG. 4 shows an example system to facilitate generation of an impact report for an area based on demographic data in communication with an automatic relief deployment system.

FIG. 5 shows an example user interface of the system to facilitate generation of an impact report for an area based on demographic data, showing 5 km GAR grids and centroids IDs, and 1 km LandScan™ where data is distributed based on population distribution ratios.

FIG. 6 shows an example user interface of the system showing 1 km grid centroid data with population ratios and area identifiers.

FIG. 7 shows an example user interface of the system showing methodology for area weighting for hazard exposure.

FIG. 8 is a block diagram of an example computing device for implementing the methods disclosed herein.

### DETAILED DESCRIPTION

The following detailed description refers to the accompanying drawings. Wherever possible, the same reference numbers are used in the drawings and the following description to refer to the same or similar elements. Many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of monitoring and assessment of built environment and demographic information by quantifying exposure of population, assets, and infrastructure to hazards, the techniques described herein are not limited to use only in this context.

Any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders.

A system to facilitate monitoring and assessment of built environment and demographic information by quantifying exposure of population, assets, and infrastructure to hazards is disclosed. Herein, the system is referred to as the All-hazard Impact Model (AIM). The AIM may provide a plurality of attributes regarding population demographics, as well as capital stock estimates that may represent a replacement value of buildings and infrastructure associated with major economic sectors.

Further, the AIM may provide information regarding vulnerability. For example, an age and income level of population may be used to estimate potential needs in an event response. Further, the AIM may provide distribution of the built environment in rural and urban settings that may be used to help estimate building construction types useful in loss modeling. In addition, the AIM may provide population distribution by occupancy categories including residential, commercial, and industrial, useful in estimating impacts, as well as urban and rural households affected. Further, the AIM may analyze and incorporate occupancy and demographic data and may allow estimation of a peak day and night population exposure for assessing impacts of no-notice events such as earthquakes in a region.

Further, the AIM may aid in determining a number of urban and rural households that may be impacted during a hazard, such as a natural disaster, or anthropogenic hazards. Further, the AIM may aid in determining an impact of a hazard on one or more demographics of individuals, such as with specific statistics as to a number of children, elderly, individuals in different income brackets, and so on. Further, the AIM may determine a value of infrastructure including numbers of hospital beds and school students that may have been impacted by the hazard, along with an estimated cost to replace. Further, the AIM may determine one or more exposed economic sectors. Further, the AIM may provide a broad range of exposure attributes that may support all phases of emergency management. For instance, the AIM may provide information at a global scale at a 1×1 km resolution, or a higher or lower resolution, as required. Further, the AIM may be implemented as a GIS Tool that may accept the input of any hazard polygon and may provide exposure information as output including summaries by country, as well as state/province. Accordingly, rapid situational awareness provided by exposure information to hazards such as tropical cyclone wind and surge, flood, earthquake shaking, wildfires, mudslides, etc. may be provided.

Further, the AIM may calculate a total exposed population and capital stock values to hazard impact areas. The AIM may be based on global datasets derived predominantly from a plurality of databases including, but not limited to Global Exposure for GAR database, Global Administrative Areas (GADM), FEMA Hazus, and so on. Further, upon combining data from the plurality of databases, a global dataset of vector data, centroids (points) created from 1 km grid cells that may contain distribution ratios and indexing to admin areas, may be created. (References to ‘admin’ are short for administrative areas, counties, states, countries.)

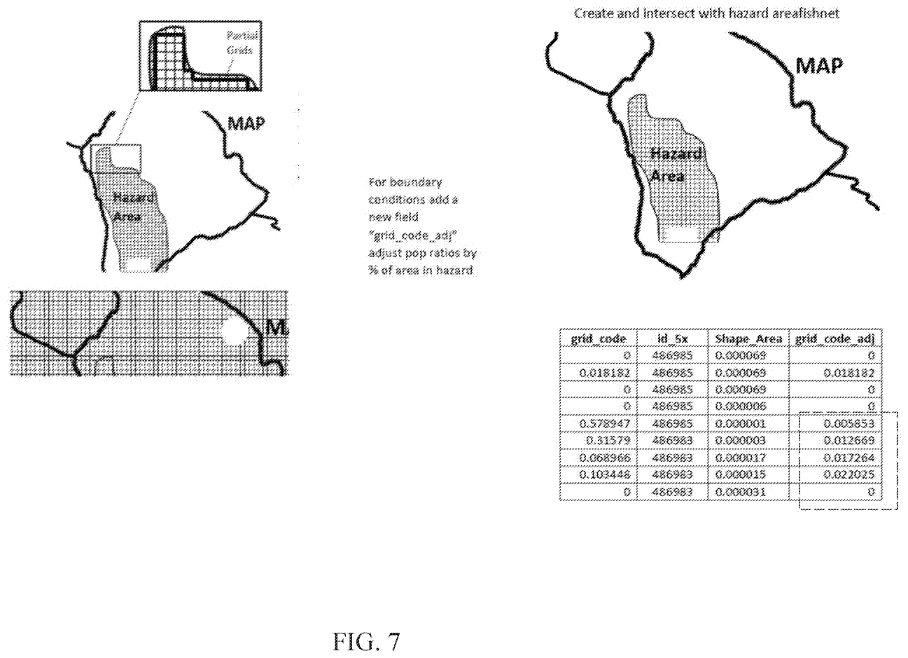

Further, the AIM may be run in a coarse or fine mode. Further, the coarse mode may use a points intersection and a 5 km resolution method which may be faster to run and useful for large multi-country scale analysis. Further, the fine mode may take geometries into account, computing area of each cell exposed to a hazard and applying the calculated ratio to produce detailed estimates. Further, the AIM may include predetermined coastal exposures for every meter (1-9) of potential coastal inundation risk using a Global 30-meter resolution Digital Elevation Model. Further, the AIM may include an area weighting process when intersecting hazard data, so only a portion of a cell exposed to a hazard may be included in exposure estimate, as shown in FIG. 7. In addition, a land versus water area in coastal cells may be preprocessed so that existing water bodies may not contribute to the estimation of flooding exposure.

Further, the AIM may process earthquake ShakeMaps, flood inundation maps, wildfire perimeters, tornado paths, etc. Further, the AIM may provide distribution of built environment in rural and urban settings that may be used to help estimate building construction types useful in loss modeling. Further, the AIM may update results based on higher resolution and more recent data, including available subnational data supporting a higher level of analysis in participating countries. Further, the AIM may aid in development of data for missing regions for which external data may not be available, such as for one or more countries.

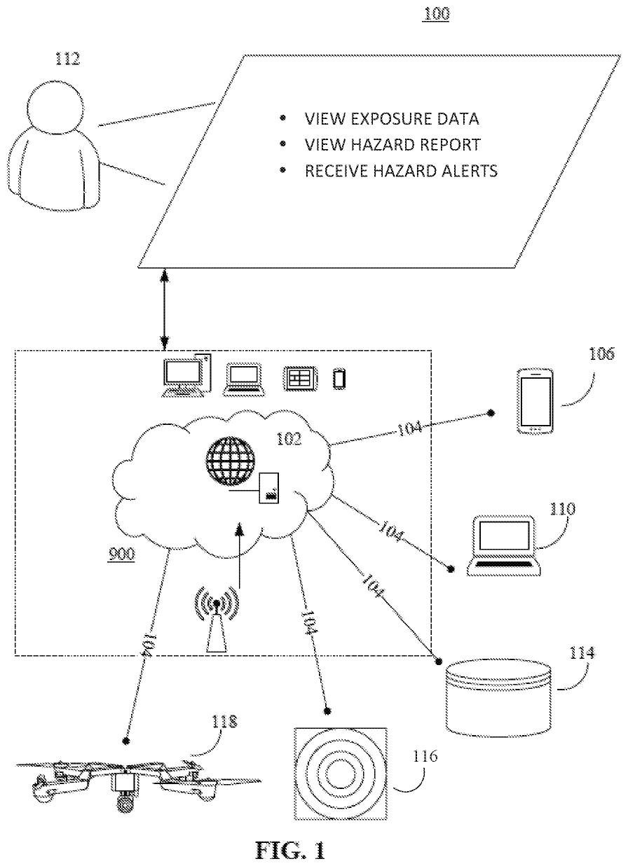

FIG. 1 is an illustration of an online platform 100. By way of non-limiting example, the online platform 100 to facilitate generation of an impact report for an area based on demographic data may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers, etc.), databases 114, sensors 116, actuators (not shown) and an apparatus 118 over a communication network 104, such as, but not limited to, the Internet. Further, users of the online platform 100 may include relevant parties such as, but not limited to, emergency service officials, end users, and administrators. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, or a mobile application compatible with a computing device 900.

The online platform 100 may be configured to facilitate generation of an impact report for an area based on demographic data. The online platform 100 may receive input related to hazard information from one or more databases, and input related to demographic information from one or more databases. The input related to hazard information may include data pertaining to a hazard, such as a type of hazard, location of origin of the hazard, a determined strength of the hazard, an actual and potential area of impact of the hazard, and so on. Further, demographic information may include a measure of population in an area, such as a state or a city. Further, demographic information may include a measure of population across one or more regions of the area, population distribution by occupancy categories in the area, data related to topography of the area, an indication of infrastructure in the area, and so on.

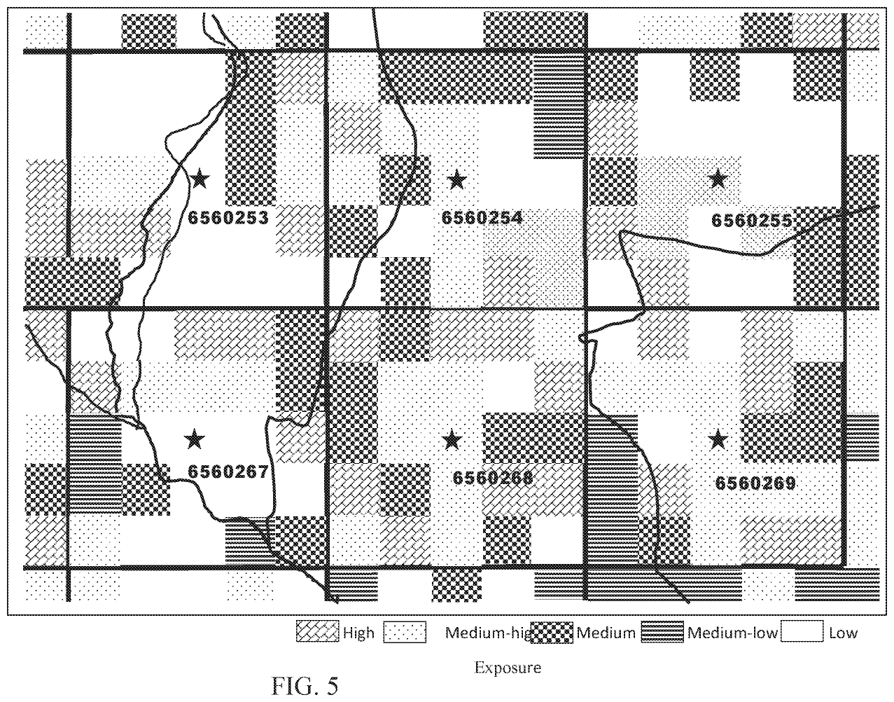

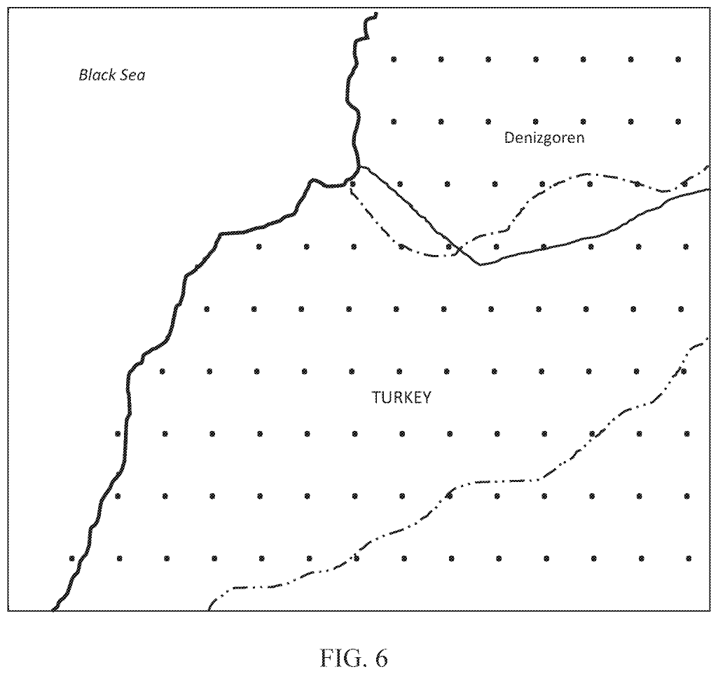

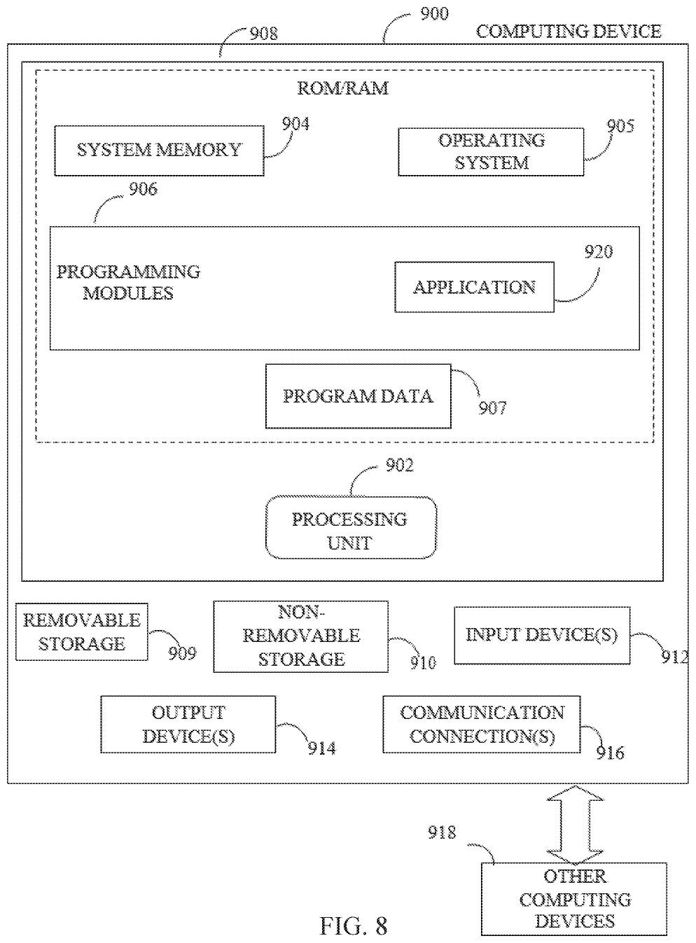

Further, the online platform 100 may analyze the hazard information, built environment, and demographic information to determine an effect of the hazard on an area, and generate an impact report for an area, as shown in FIG. 8. The impact report may describe the effect of the hazard on an area. For instance, the impact report may provide information regarding vulnerability. For example, the impact report may describe age and income level of population of an area, along with estimated potential needs. Further, the impact report may provide a distribution of affected infrastructure, including in rural and urban regions of the area, and may describe building construction types that may be useful in loss modeling. Further, the impact report may provide population distribution by occupancy categories including residential, commercial, and industrial, and estimated impacts on the population of the area, as well as urban and rural households affected. Further, the impact report may describe and incorporate occupancy and demographic data, and a peak day and night population exposure to describe impacts of no-notice events such as earthquakes in the area. Further, the impact report may describe a number of urban and rural households that may be impacted during the hazard. Further, the impact report may describe the impact of the hazard on one or more demographics of individuals, such as specific statistics as to a number of children, elderly, individuals in different income brackets, and so on. Further, the impact report may include a value of infrastructure that may have been impacted by the hazard, along with an estimated cost to replace. Further, the impact report may include one or more exposed economic sectors, along with a broad range of exposure attributes that may support all phases of emergency management, such as state of infrastructure, electrical power, telecommunication, and so on. For instance, the impact report may be provided as a geospatial vector data format for geographic information system (GIS) software, such as a shapefile, which may be viewable in ArcGIS. For instance, the impact report may provide information at a global scale at a 1×1 km resolution, or a higher or lower resolution, as required. Further, the impact report may provide exposure information as output including summaries by country, as well as state/province. Further, the impact report may provide a global dataset of vector data, centroids (points) created from 1 km grid cells that may contain distribution ratios and indexing to admin areas, as shown in FIG. 6. Further, the impact report may be viewable in a coarse or fine mode. Further, the coarse mode may use a points intersection and a 5 km resolution method, as shown in FIG. 5 which may be faster to run and useful for large multi-country scale analysis.

Further, the fine mode may take geometries into account, computing area of each cell exposed to a hazard and applying the calculated ratio to produce detailed estimates.

Further, the impact report may be used to control one or more aspects of relief deployment, such as through an automated relief deployment system in communication with the online platform 100. For instance, one or more alerts, including the type of hazard, area of impact, one or more protective measures, and so on, may be transmitted to one or more user devices included/in communication with the relief deployment system. Further, one or more automated real-time relief deployment drones connected to the relief deployment system may be controlled on the basis of the impact report to provide relief supplies and material after the hazard impact. For instance, the automated real-time relief deployment drones may be controlled to provide relief material to one or more regions of the area where the effect of the hazard may have been determined to be at a maximum. Further, one or more autonomous vehicles may be controlled to provide relief resources to the area. Further, the impact data may be used to control deployment of emergency services in one or more required regions of the area, such as fire brigade and ambulance.

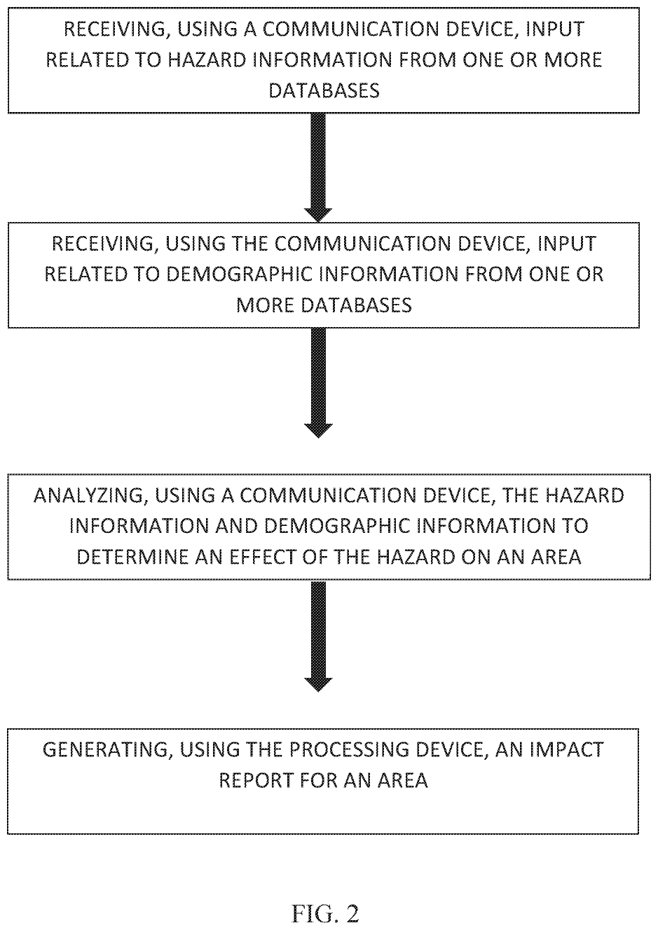

FIG. 2 shows a flowchart of an example method to generate an impact report for an area based on the built environment and demographic data. Accordingly, the method may include receiving, using a communication device, input related to hazard information from one or more databases. The input related to hazard information may include data pertaining to a hazard, such as a type of hazard, location of origin of the hazard, a determined strength of the hazard, an actual and potential area of impact of the hazard, and so on. For instance, the type of hazard may include a natural hazard, such as a cyclone, earthquake, flood, and so on, or an anthropogenic hazard, such as wildfires (caused by human negligence or arson), chemical leaks, and so on. Further, the location of origin of the hazard may describe a location or an area from where the hazard may have originated. Further, a determined or estimated strength of the hazard may be related to the particular hazard. For instance, the strength of a cyclone may include a categorization and wind speeds associated with the cyclone; the strength of an earthquake may include ground shaking intensity of the earthquake; the strength of a wildfire may include a Fire Radiative Power; and so on. Further, an actual and potential area of impact may include an area where the hazard may have impacted and may be estimated to impact after a period of time. For instance, if the hazard is a flood, an area of land that may be inundated may correspond to the actual area of impact. Further, one or more surrounding areas that may be inundated may be determined to be potential or estimated areas of impact. Further, the input related to the hazard information may be received from one or more databases, such as global datasets derived from databases including, but not limited to, FEMA Hazus, databases maintained by metrological departments, ShakeMap “shapefiles”, databases maintained by other credible modeling outfits, such as Kinetics' The Arbitrator Of Storms (TAOS) wind and (still-water) storm surge models, and so on. Further, the input related to the hazard information may be received from one or more sensors, such as weather sensors, including but not limited to, wind speed sensors, wind direction sensors, barometric sensors, humidity sensors, water surface temperature sensors, and so on. Further, input related to the hazard information may be received from one or more satellite images. Further, input related to the hazard information may be received from one or more dedicated equipment used to determine the presence of hazards, such as seismographs, and so on.

Further, the method may include receiving, using a communication device, input related to demographic information from one or more databases. Demographic information may include a measure of population in an area, such as a state or a city. Further, demographic information may include a measure of population across one or more regions of the area. Further, demographic information may include population distribution by occupancy categories in the area, including residential occupancy, commercial occupancy, and industrial occupancy. Further, demographic information may include data related to topography of the area, including an elevation and type of terrain in the area. Further, demographic information may include an indication of infrastructure in the area, including roads, bridges, tunnels, water supply, sewers, electrical grids, telecommunications, and so on. Further, the indication of infrastructure in the area may include details about infrastructure, including educational institutes, such as schools, parks and recreational facilities, law enforcement agencies, and emergency services. Further, the indication of infrastructure in the area may include details about one or more important infrastructures, such as airports, railway stations, docks, and so on. Further demographic data may include indication of one or more types of industries in the area, such as factories, docks, manufacturing plants, power stations, and so on. Further, demographic information may include an indication of peak day and night population exposure in the area, such as areas of peak populations in the area, along with an indication of the population. Further, the demographic information may be received from one or more databases, such as datasets derived from databases including, but not limited, to Global Exposure for GAR (GEG) database, LandScan™ global population database, Global Administrative Areas (GADM), Populated Places, World Urban Areas, and FEMA Hazus. Further, the demographic information may be received from one or more user devices of one or more individuals in the area, for example through social media feeds of one or more individuals.

Further, the method may include analyzing, using a communication device, the hazard information and demographic information to determine an effect of the hazard on an area. The effect of the hazard on the area may be determined by correlating the hazard information to the demographic information. For instance, the location from where the hazard may have originated, and the determined or estimated strength of the hazard may describe an area or impact of the hazard. Further, demographic information associated with the area of impact of the hazard may describe the effect of the hazard. For instance, if the hazard is a cyclone, the location where the cyclone hits, and the strength of the cyclone, including the categorization, and wind speeds may describe the area of impact of the cyclone. Further, the demographic information, including the population, population density, information about infrastructure, and so on, may describe the effect of the hazard on the area, such as a number of people adversely affected by the hazard. As an example, if the hazard is an earthquake, the strength of the earthquake may include ground shaking intensity based on the Modified Mercalli Intensity scale. Accordingly, hazard information may include information such as an epicenter of the earthquake. Further, demographic information including the indication of infrastructure including roads, bridges, electrical grids, telecommunications, and so on, may be correlated with the hazard information to determine a potential effect of the hazard. Further, the demographic information may include peak population exposure in the area and may be correlated to determine an effect of the hazard on the peak day or night population.

Further, the method may include generating, using the processing device, an impact report for an area. The impact report may describe the effect of the hazard on an area. For instance, the impact report may provide information regarding vulnerability. For example, the impact report may describe age and income level of population of an area along with estimated potential needs. Further, the impact report may provide exposure estimates, describing and/or displaying population, infrastructure, systems, or other elements present in hazard zones that may have been subject to potential losses. Further, the impact report may provide a distribution of affected infrastructure, including in rural and urban regions of the area, and may describe building construction types that may be useful in loss modeling. Further, the impact report may provide population distribution by occupancy categories including residential, commercial, and industrial, and estimated impacts on the population of the area, as well as urban and rural households affected. Further, the impact report may describe and incorporate occupancy and demographic data, and a peak day and night population exposure to describe impacts of no-notice events such as earthquakes in the area. Further, the impact report may describe a number of urban and rural households that may be impacted during the hazard. Further, the impact report may describe impact of the hazard on one or more demographics of individuals, such as with specific statistics as to a number of children, elderly, individuals in different income brackets, and so on. Further, the impact report may include a value of infrastructure that may have been impacted by the hazard, along with an estimated cost to replace. Further, the impact report may include one or more exposed economic sectors, along with a broad range of exposure attributes that may support all phases of emergency management, such as state of infrastructure, electrical power, telecommunication, and so on. For instance, the impact report may be provided as a geospatial vector data format for geographic information system (GIS) software, such as a shapefile, which may be viewable in ArcGIS. For instance, the impact report may provide information at a global scale at a 1×1 km resolution, or a higher or lower resolution, as required. Further, the impact report may provide exposure information as output including summaries by country, as well as state/province. Further, the impact report may provide a global dataset of vector data, centroids (points) created from 1 km grid cells that may contain distribution ratios and indexing to admin areas. Further, the impact report may be viewable in a coarse or fine mode. Further, the coarse mode may use a points intersection and a 5 km resolution method which may be faster to run and useful for large multi-country scale analysis. Further, the fine mode may take geometries into account, computing area of each cell exposed to a hazard and applying the calculated ratio to produce detailed estimates. Further, the hazard may include area weighting when intersecting hazard data, so only a portion of a cell exposed to a hazard may be included in exposure estimate, as shown in FIG. 7. Further, the impact report may be generated in one or more file formats, such as excel summaries and database tables.

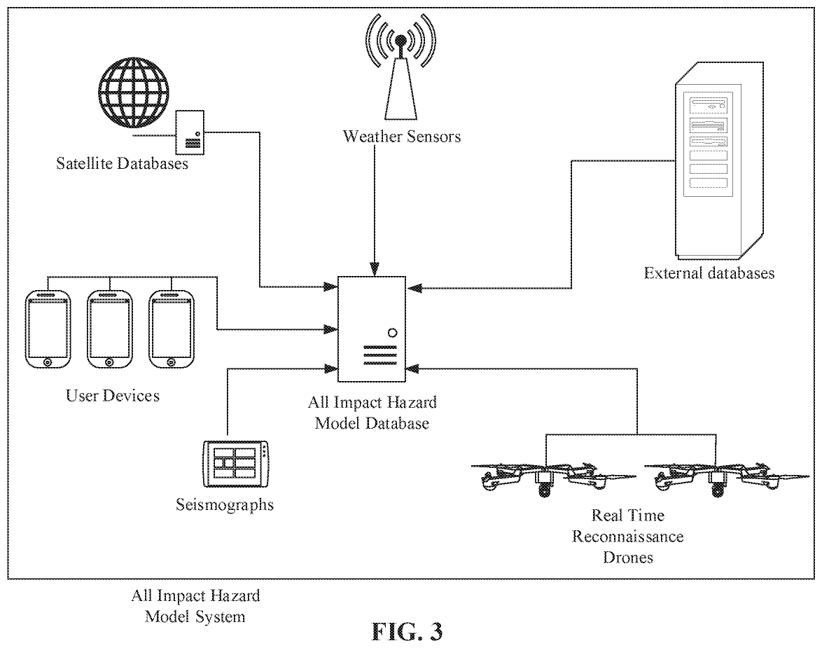

FIG. 3 shows an example system to facilitate generation of an impact report for an area based on demographic data. For instance, the system may be called an All-hazard Impact Model (AIM) system. Further, the system may include a central database, known as, for instance, the All-hazard Impact Model (AIM) database. The All-hazard Impact Model (AIM) database may be configured to receive, using a communication device, input related to hazard information from one or more sources in the system. The input related to hazard information may include data pertaining to a hazard, such as a type of hazard, location of origin of the hazard, a determined strength of the hazard, an actual and potential area of impact of the hazard, and so on. For instance, the type of hazard may include a natural hazard, such as a cyclone, earthquake, flood, and so on, or an anthropogenic hazard, such as wildfires (caused by human negligence or arson), chemical leaks, and so on. Further, the location of origin of the hazard may describe a location, or an area from where the hazard may have originated. Further, a determined or estimated strength of the hazard may be related to the particular hazard. For instance, the strength of a cyclone may include a categorization and wind speeds associated with the cyclone, the strength of an earthquake may include ground shaking intensity based on the Modified Mercalli Intensity scale, the strength of a wildfire may include a Fire Radiative Power, and so on. Further, an actual and potential area of impact may include an area where the hazard may have impacted, and may be estimated to impact after a period of time. For instance, if the hazard is a flood, an area of land that may be inundated may correspond to the actual area of impact. Further, one or more surrounding areas that may be inundated may be determined to be potential, or estimated areas of impact. Further, the input related to the hazard information may be received from one or more databases, such as global datasets derived from databases including, but not limited to TAOS wind fields or surge zones, FEMA Hazus, databases maintained by metrological departments, ShakeMap “shapefiles”, and so on. Further, the input related to the hazard information may be received from one or more sensors, such as weather sensors, including but not limited to wind speed sensors, wind direction sensors, barometric sensors, humidity sensors, water surface temperature sensors, and so on. Further, input related to the hazard information may be received from one or more satellite databases. Further, input related to the hazard information may be received from one or more dedicated equipment used to determine presence of hazards, such as seismographs, and so on. Further, the system may receive hazard information in real time from reconnaissance drones equipped with one or more monitoring sensors, such as cameras, audio sensors, and so on. Further, the All-hazard Impact Model (AIM) database may be configured to receive input related to demographic information from one or more sources. Demographic information may include a measure of population in an area, such as a state, or a city. Further, demographic information may include a measure of population across one or more regions of the area. Further, demographic information may include population distribution by occupancy categories in the area including residential occupancy, commercial occupancy, and industrial occupancy. Further, demographic information may include data related to topography of the area, including an elevation, and type of terrain in the area. Further, demographic information may include an indication of infrastructure in the area, including roads, bridges, tunnels, water supply, sewers, electrical grids, telecommunications, and so on. Further, the indication of infrastructure in the area may include details about infrastructure including educational institutes, such as schools, parks and recreational facilities, law enforcement agencies, and emergency services. Further, the indication of infrastructure in the area may include details about one or more important infrastructure, such as airports, railway stations, docks, and so on. Further demographic data may include an indication of one or more types of industries in the area, such as factories, docks, manufacturing plants, power stations, and so on. Further, demographic information may include an indication of peak day and night population exposure in the area, such as areas of peak populations in the area, along with an indication of the population. Further, the demographic information may be received from one or more databases, such as, but not limited to, global datasets derived from databases including, but not limited to Global Exposure for GAR (GEG) database, LandScan™ global population database, Global Administrative Areas (GADM), Populated Places, World Urban Areas, and FEMA Hazus. Further, the demographic information may be received from one or more user devices of one or more individuals in the area, such as through social media feeds of the one or more individuals. Further, the All-hazard Impact Model (AIM) may be configured to analyze the hazard information and demographic information to determine the effect of the hazard on an area. The effect of the hazard on the area may be determined by correlating the hazard information to the built environment and demographic information. For instance, the location from where the hazard may have originated, and the determined or estimated strength of the hazard may describe an area or impact of the hazard. Further, demographic information associated with the area of impact of the hazard may describe the effect of the hazard. For instance, if the hazard is a cyclone, the location where the cyclone hits and the strength of the cyclone, including the categorization and wind speeds, may describe the area of impact of the cyclone. Further, the demographic information, including the population, population density, information about infrastructure, and so on, may describe the effect of the hazard on the area, such as a number of people adversely affected by the hazard. Further, the All-hazard Impact Model (AIM) may be configured to generate an impact report for an area. The impact report may describe the effect of the hazard on an area. For instance, the impact report may provide information regarding vulnerability. For example, the impact report may describe age and income level of population of an area along with estimated potential needs. Further, the impact report may provide a distribution of affected infrastructure, including in rural and urban regions of the area and may describe building construction types that may be useful in loss modeling. Further, the impact report may provide population distribution by occupancy categories including residential, commercial, and industrial, and estimated impacts on the population of the area, as well as urban and rural households affected. Further, the impact report may describe and incorporate occupancy and demographic data, and a peak day and night population exposure to describe impacts of no-notice events such as earthquakes in the area. Further, the impact report may describe a number of urban and rural households that may be impacted during the hazard. Further, the impact report may describe impact of the hazard on one or more demographics of individuals, such as with specific statistics as to a number of children, elderly, individuals in different income brackets, and so on. Further, the impact report may include a value of infrastructure that may have been impacted by the hazard, along with an estimated cost to replace. Further, the impact report may include one or more exposed economic sectors, along with a broad range of exposure attributes that may support all phases of emergency management, such as state of infrastructure such as electrical power, telecommunication, and so on. For instance, the impact report may be provided as a geospatial vector data format for geographic information system (GIS) software, such as a shapefile, which may be viewable in ArcGIS. For instance, the impact report may provide information at a global scale at a 1×1 km resolution, or a higher or lower resolution, as required. Further, the impact report may provide exposure information as output including summaries by country, as well as state/province. Further, the impact report may provide a global dataset of vector data, centroids (points) created from 1 km grid cells that may contain distribution ratios and indexing to admin areas. Further, the impact report may be viewable in a coarse or fine mode. Further, the coarse mode may use a points intersection and a 5 km resolution method which may be faster to run and useful for large multi-country scale analysis. Further, the fine mode may take geometries into account, computing area of each cell exposed to a hazard and applying the calculated ratio to produce detailed estimates.

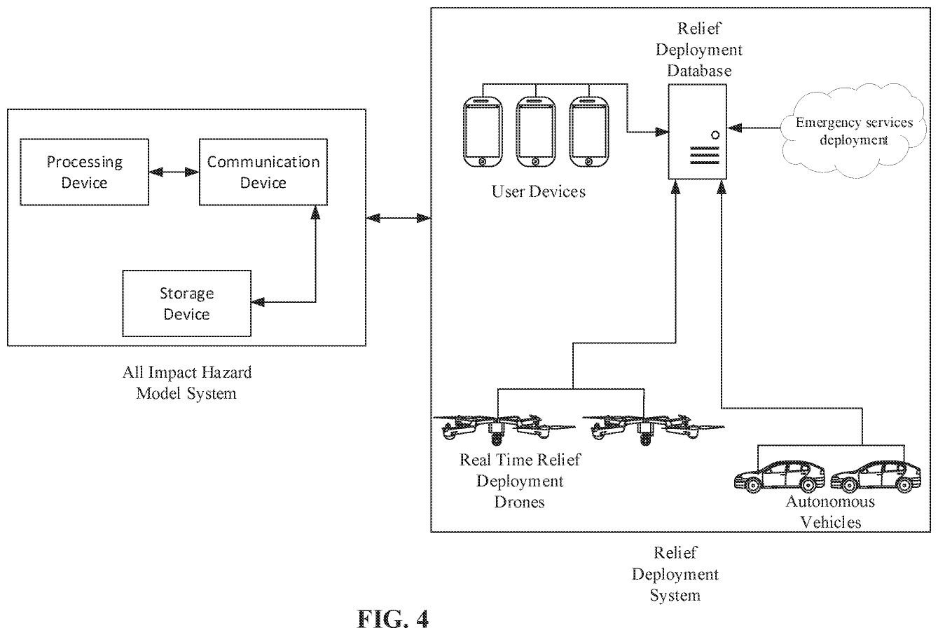

FIG. 4 shows an example system to facilitate generation of an impact report for an area based on demographic data in communication with an automatic relief deployment system. For instance, the system to facilitate generation of an impact report for an area based on demographic data may be called as All-hazard Impact Model (AIM) system. The AIM may include a communication device configured to receive input related to hazard information from one or more databases, and input related to demographic information from one or more databases. The input related to hazard information may include data pertaining to a hazard, such as a type of hazard, location of origin of the hazard, a determined strength of the hazard, an actual and potential area of impact of the hazard, and so on. Further, demographic information may include a measure of population in an area, such as a state, or a city. Further, demographic information may include a measure of population across one or more regions of the area, population distribution by occupancy categories in the area, data related to topography of the area, an indication of infrastructure in the area, and so on.

Further, the AIM may include a processing device configured to analyze the hazard information and demographic information to determine an effect of the hazard on an area, and generate an impact report for the area. The impact report may describe the effect of the hazard on an area. For instance, the impact report may provide information regarding vulnerability. For example, the impact report may describe age and income level of population of an area along with estimated potential needs. Further, the impact report may provide a distribution of affected infrastructure, including in rural and urban regions of the area and may describe building construction types that may be useful in loss modeling. Further, the impact report may provide population distribution by occupancy categories including residential, commercial, and industrial, and estimated impacts on the population of the area, as well as urban and rural households affected. Further, the impact report may describe and incorporate occupancy and demographic data, and a peak day and night population exposure to describe impacts of no-notice events such as earthquakes in the area. Further, the impact report may describe a number of urban and rural households that may be impacted during the hazard. Further, the impact report may describe impact of the hazard on one or more demographics of individuals, such as with specific statistics as to a number of children, elderly, individuals in different income brackets, and so on. Further, the impact report may include a value of infrastructure that may have been impacted by the hazard, along with an estimated cost to replace. Further, the impact report may include one or more exposed economic sectors, along with a broad range of exposure attributes that may support all phases of emergency management, such as state of infrastructure such as electrical power, telecommunication, and so on. For instance, the impact report may be provided as a geospatial vector data format for geographic information system (GIS) software, such as a shapefile, which may be viewable in ArcGIS. For instance, the impact report may provide information at a global scale at a 1×1 km resolution, or a higher or lower resolution, as required. Further, the impact report may provide exposure information as output including summaries by country, as well as state/province. Further, the impact report may provide a global dataset of vector data, centroids (points) created from 1 km grid cells that may contain distribution ratios and indexing to admin areas. Further, the impact report may be viewable in a coarse or fine mode. Further, the coarse mode may use a points intersection and a 5 km resolution method which may be faster to run and useful for large multi-country scale analysis. Further, the fine mode may take geometries into account, computing area of each cell exposed to a hazard and applying the calculated ratio to produce detailed estimates. Further, the impact report may be used to control one or more aspects of relief deployment, such as through an automated relief deployment system in communication with the AIM. For instance, one or more alerts, including the type of hazard, area of impact, one or more protective measures, and so on, may be transmitted to one or more user devices included/in communication with the relief deployment system. Further, one or more automated real-time relief deployment drones connected to the relief deployment system may be controlled on the basis of the impact report to provide relief supplies and materials after the hazard. For instance, the automated real-time relief deployment drones may be controlled to provide relief materials to one or more regions of the area where the effect of the hazard may have been determined to be maximum. Further, one or more autonomous vehicles may be controlled to provide relief resources to the area. Further, the impact data may be used to control deployment of emergency services in one or more required regions of the area, such as fire brigade, and ambulance.

With reference to FIG. 8, a system, such as the AIM, may include a computing device or cloud service, such as computing device 900. In a basic configuration, computing device 900 may include at least one processing unit 902 and a system memory 904. Depending on the configuration and type of computing device, system memory 904 may comprise, but is not limited to, volatile (e.g., random-access memory (RAM)), non-volatile (e.g., read-only memory (ROM)), flash memory, or any combination. System memory 904 may include operating system 905, one or more programming modules 906, and may include a program data 907. Operating system 905, for example, may be suitable for controlling computing device 900's operation. Programming modules 906 may include image-processing module, machine learning module, and/or image classifying module. The system may use or be used with a graphics library, other operating systems, or any other application program and is not limited to any particular application or system. This basic configuration is illustrated in FIG. 8 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 8 by a removable storage 909 and a non-removable storage 910. Computer storage media may include volatile and non-volatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, a location sensor, a camera, a biometric sensor, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and without limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g., application 920 such as a media player) may perform processes including, for example, one or more stages of methods, algorithms, systems, applications, servers, or databases, as described above. The aforementioned process is an example, and processing unit 902 may perform other processes. Other programming modules that may be used include sound encoding/decoding applications, machine learning application, acoustic classifiers, etc.

Generally, program modules may include routines, programs, components, data structures, and other types of structures that may perform particular tasks or that may implement particular abstract data types. Moreover, the techniques described herein may be practiced with other computer system configurations, including hand-held devices, general purpose graphics processor-based systems, multiprocessor systems, microprocessor-based or programmable consumer electronics, application-specific integrated circuit-based electronics, minicomputers, mainframe computers, and the like. The techniques described herein may also be practiced in distributed computing environments where tasks are performed by remote processing devices that are linked through a communications network. In a distributed computing environment, program modules may be located in both local and remote memory storage devices.

Furthermore, the techniques described herein may be practiced in an electrical circuit comprising discrete electronic elements, packaged or integrated electronic chips containing logic gates, a circuit utilizing a microprocessor, or on a single chip containing electronic elements or microprocessors. The techniques may also be practiced using other technologies capable of performing logical operations such as, for example, AND, OR, and NOT, including but not limited to mechanical, optical, fluidic, and quantum technologies. In addition, the techniques may be practiced within a general-purpose computer or in any other circuits or systems.

The techniques disclosed herein, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., a USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

We claim:

1. A computer-implemented method, comprising:
receiving input related to hazard information from a first database; and
generating, based on the hazard information, built environment, and demographic data, an impact report for an area.

2. The method of claim 1, further comprising receiving input related to the demographic information from a second database.

3. The method of claim 1, further comprising determining, based on the hazard information and the demographic data, an effect of a hazard on the area.

4. An apparatus comprising a processor, a memory, and communication circuitry, the apparatus being connected to a network via the communication circuitry, the apparatus further comprising computer-executable instructions stored in the memory which, when executed by the processor, cause the apparatus to generate of an impact report for an area based on built environment, demographic data, and hazard information.

5. The apparatus of claim 4, wherein the instructions further cause the apparatus to receive, via a communications device, input related to the hazard information from a first database, and input related to the built environment from a second database, and the demographic data from a third database.

6. The apparatus of claim 4, wherein the instructions further cause the apparatus to determine an effect of a hazard on the area.

7. The apparatus of claim 4, wherein the instructions further cause the apparatus to monitor and assess potential impacts off a hazard on the built environment and a population associated with the demographic information by quantifying exposure of the population, assets, and infrastructure to the hazards.
